(19) United States
(12) Patent Application Publication
(10) Pub. No.: US 2006/0185000 A1
(43) Pub. Date: Aug. 17, 2006

(54) System and method for creating access authority and remote controller using the same

(75) Inventors: Bum-jin Im, Yongin-si (KR); Kyung-hee Lee, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/350,771

(22) Filed: Feb. 10, 2006

(30) Foreign Application Priority Data
Feb. 15, 2005 (KR) 2005-0012311

(51) Int. Cl. H04L 9/32

(52) U.S. Cl. 726/3

(57) ABSTRACT

A system and a method for creating an access authority and a remote controller using the system and the method. The system includes: at least one lower remote controller which requests a creation of an access authority; a higher remote controller which receives the request for the creation of the access authority from the at least one lower remote controller, creates an access authority to be granted to the lower remote controller, and requests a registration of the created access authority. Also included is a device which receives the request for the registration of the created access authority from the higher remote controller and registers the access authority of the lower remote controller created by the higher remote controller.

### CROSS-REFERENCE TO RELATED APPLICATIONS

This application claims the benefit under 35 U.S.C. § 119 (a) of Korean Patent Application No. 10-2005-0012311 filed on Feb. 15, 2005, in the Korean Intellectual Property Office, the disclosure of which is incorporated herein by reference.

### BACKGROUND OF THE INVENTION

1. Field of the Invention

Apparatuses and methods consistent with the present invention relate to creating an access authority and a remote controller using the same, and more particularly, to a system and a method for creating an access authority by which a specific user can provide another user an access authority to a device and a remote controller using the same.

2. Description of the Related Art

In modern society there has been a flood of information, such that various types of contents are indiscreetly offered. Anyone can view programs provided through image display devices, such as televisions, which anyone can use to easily access image media, regardless of the programs' contents.

Thus, a program ranking system has been introduced to classify programs by contents that may have harmful influences on children and young adults, for example, violence, sexuality, and language usage. Also, the ranks of the programs are displayed on screens of televisions.

In other words, ages allowed to view specific programs are displayed on predetermined portions of the screens so that the minor's guardians, for example, in the homes restrict program viewing based on the program's rank. However, this mode of restriction is possible only when the guardians view television together with the minors. Thus, self-controlled viewing regulations of curious minors cannot be expected.

To solve these problems, there has been used a method by which users can check information regarding ranks of corresponding programs through data of vertical blanking interval (VBI) areas called V-chips and input passwords so that only users knowing the passwords can view the corresponding programs.

In the V-chip-based viewing regulation method, passwords are differently set depending on the types of devices. Thus, it is difficult to set the passwords, and the set passwords must be remembered.

Also, the passwords may be exposed. Even in a case where guardians, who do not need to be regulated, desire to view adult programs, in addition to programs that can be viewed regardless of age, such as education programs, the guardians must input passwords to view the programs.

U.S. Patent Publication No. 2003-0237088 discloses a method of separately configuring a remote controller for guardians and a remote controller for their children, to regulate minors' viewing of adult programs.

In other words, all kinds of programs including adult programs can be viewed through the remote controller for the guardians, but only programs corresponding to set ranks can be viewed through the remote controller for the children.

In a manner different from the V-chip-based viewing regulation method, this method solves the troublesomeness of remembering passwords. However, the remote controller for the guardians must be especially managed so that the children cannot use it.

### SUMMARY OF THE INVENTION

An aspect of the present invention is to provide a system and a method for creating an access authority by which a specific user can provide another user with access authority to a device so as to communicate with the device within a range of an access authority authorized to the specific user and a remote controller using the system and the method.

According to an exemplary aspect of the present invention, there is provided a system for creating an access authority, including: at least one lower remote controller requesting a creation of an access authority; a higher remote controller receiving the request for the creation of the access authority from the at least one lower remote controller, creating an access authority to be granted to the lower remote controller, and requesting a registration of the created access authority; and a device receiving the request for the registration of the created access authority from the higher remote controller and registering the access authority of the lower remote controller created by the higher remote controller.

The lower remote controller may request the higher remote controller to create the access authority through a location limited channel.

According to another exemplary aspect of the present invention, there is provided a system for creating an access authority, including: a remote controller granting higher and lower authorities to a plurality of users through a user authentication, and if the user having the higher access authority creates an access authority to be granted to the user having the lower access authority, requesting a registration of the created access authority; and a device receiving the request for the registration of the created access authority from the remote controller and registering the access authority of the user having the lower access authority, the access authority being created by the user having the higher access authority.

Before creating the access authority to be granted to the user having the lower access authority, the remote controller may request the device for permission information. The remote controller may transmit the request for the permission information along with a hash of a public key of the user having the lower access authority.

The device may offer the remote controller the permission information in a webpage form. The device may offer the permission information along with a hash of its public key.

If the access authority of the user having the lower access authority is higher than an access authority of the user having the higher access authority, the device may reject to create the access authority.

The device and the remote controller may perform communications with each other within a range of the created access authority using a public key-based algorithm.

According to still another exemplary aspect of the present invention, there is provided a method of creating an access authority in a system including a higher remote controller, at least one lower remote controller, and a device operated by the higher remote controller and the at least one lower remote controller, including: requesting the higher remote controller to create an access authority via the at least one lower remote controller; creating an access authority to be granted to the lower remote controller via the higher remote controller and requesting the device to register the created access authority; and registering the access authority of the lower remote controller created by the higher remote controller via the device. The lower remote controller may request the higher remote controller to create the access authority through a location limited channel.

According to yet another exemplary aspect of the present invention, there is provided a method of creating an access authority in a system including a remote controller and a device operated by the remote controller, including: granting, by the remote controller, higher and lower access authorities to a plurality of users through a user authentication; creating, by the remote controller, an access authority to be granted to the user having the lower access authority via the user having the higher access authority and requesting the device to register the created access authority; and registering, by the device, the access authority of the user having the lower access authority, the access authority being created by the user having the higher access authority.

Before creating the access authority, the method may further include: requesting the device for permission information via the remote controller. The remote controller may transmit the request for the permission information along with a hash of a public key of the user having the lower access authority.

The method may further include: offering the remote controller the permission information in a webpage form via the device. The device may offer the permission information along with a hash of its public key.

If the access authority of the user having the lower access authority is higher than the access authority of the user having the higher access authority, the device may reject to create the access authority.

The method may further include: performing communications between the device and the remote controller within a range of the created access authority using a public key-based algorithm.

According to yet another exemplary aspect of the present invention, there is provided a remote controller including: a user authenticator granting higher and lower access authorities to a plurality of users via a predetermined serial key; if the user having the lower access authority requests a creation of an access authority, a controller creating an access authority to a device via the user having the higher access authority, the access authority to be granted to the user having the lower access authority; and a device interface requesting the device to register the created access authority.

According to yet another exemplary aspect of the present invention, there is provided a remote controller including: a remote controller interface receiving a request for a creation of an access authority through a location limited channel from another remote controller; a controller receiving the request for the creation of the access authority and creating an access authority to a device, the access authority to be granted to the another remote controller; and a device interface requesting the device to register the created access authority.

### BRIEF DESCRIPTION OF THE DRAWINGS

The above aspects of the present invention will be more apparent by describing certain exemplary embodiments of the present invention with reference to the accompanying drawings, in which:

FIG. 1 is a view illustrating a configuration of a system for creating an access authority according to an exemplary embodiment of the present invention;

FIG. 2 is a block diagram of a remote controller shown in FIG. 1;

FIG. 3 is a view illustrating a configuration of a system for creating an access authority according to another exemplary embodiment of the present invention;

FIG. 4 is a block diagram of a higher remote controller shown in FIG. 3;

FIG. 5 is a flowchart of a method of creating an access authority according to an exemplary embodiment of the present invention; and

FIG. 6 is a flowchart of a method of creating an access authority according to another exemplary embodiment of the present invention.

### DETAILED DESCRIPTION OF THE EXEMPLARY EMBODIMENTS

Certain embodiments of the present invention will be described in greater detail with reference to the accompanying drawings. In the following description, same drawing reference numerals are used for the same elements even in different drawings.

FIG. 1 is a view illustrating a configuration of a system for creating an access authority according to an exemplary embodiment of the present invention. Referring to FIG. 1, the system includes a device 100 and a remote controller 200. Here, the system includes one remote controller 200.

The device 100 is controlled by the remote controller 200 that will be described later. The device 100 may be one of various types of devices requiring restrictions on access authorities of individual users such as Audio/Video devices, for example, televisions providing various contents, personal computers (PCs), home games, and the like.

If the remote controller 200 requests the device 100 of the present exemplary embodiment for predetermined permission information, the device 100 offers the corresponding permission information to the remote controller 200. Here, the device 100 may offer the remote controller 200 the permission information in a webpage form. The device 100 may offer the permission information with a hash of a public key thereof.

If the remote controller 200 requests the device 100 to register an access authority, the device 100 may register an access authority of a user having a lower access authority, the access authority being created by a user having a higher access authority, such as a guardian, for example.

If the access authority of the user having the lower access authority is indicated as being higher or greater than an access authority of the user having the higher access authority, the device 100 may reject to register the access authority of the user having the lower access authority. Here, it is presumed that the access authority of the user having the higher access authority has been already registered in the device 100.

The remote controller 200 can control the device 100 at a remote distance and may be a portable wireless terminal, such as a cellular phone or personal digital assistant (PDA).

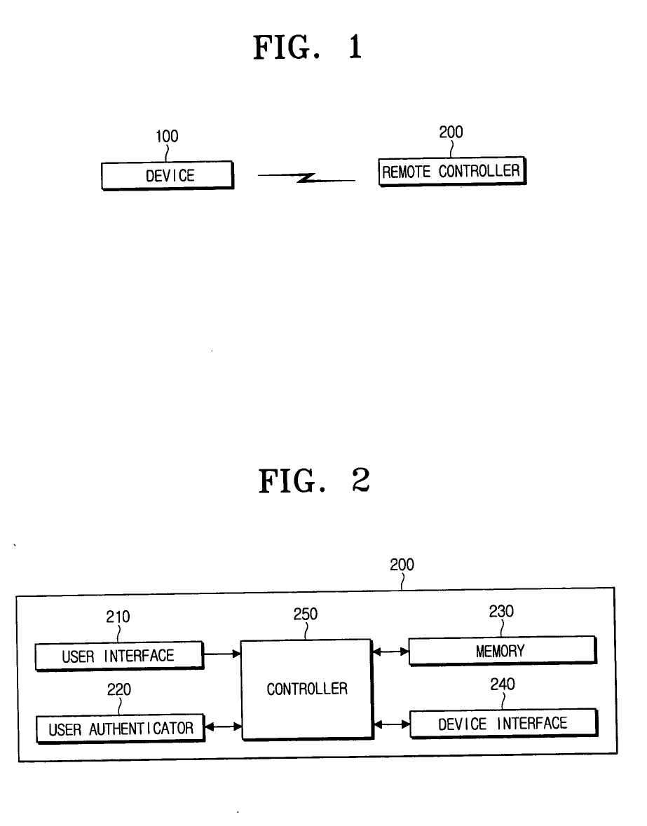

The remote controller 200 of the present exemplary embodiment grants higher and lower access authorities to a plurality of users. Also, if the user having the higher access authority creates an access authority to be granted to the user having the lower access authority, the remote controller 200 requests the device 100 to register the created access authority. The remote controller 200 will be described in more detail later with reference to FIG. 2.

The device 100 and the remote controller 200 may perform communications with each other within a range of the access authority created by the user having the higher access authority using a public key-based algorithm

FIG. 2 is a block diagram of the remote controller 200 shown in FIG. 1. Referring to FIG. 2, the remote controller 200 applied to the system for creating the access authority according to the present exemplary embodiment includes a user interface 210, a user authenticator 220, a memory 230, a device interface 240, and a controller 250.

The user interface 210 interfaces the users with the remote controller 200 and may receive a serial key for authenticating the users through manipulations of the users.

The user authenticator 220 compares the serial key input through the user interface 210 with a serial key stored in the memory 230 that will be described later to authenticate the users. The user authenticator 220 may grant the higher and lower access authorities through serial keys associated with the plurality of users.

The memory 230 stores the serial keys of the plurality of users and the public key of the remote controller 200. Here, the public key includes public keys of the users having the higher and lower access authorities.

The device interface 240 interfaces the device 100 with the remote controller 200 and is controlled by the controller 250, which will be described later, to request the device 100 to register access authorities. The device interface 240 is also controlled by the controller 250 to request the device 100 for the permission information.

The controller 250 controls the overall operation of the remote controller 200 and controls inputs and outputs of a signal among the user interface 210, the user authenticator 220, the memory 230, and the device interface 240.

If the user having the lower access authority requests the remote controller 200 to create an access authority through the user interface 210, the controller 250 creates an access authority that the user having the higher access authority is to grant to the user having the lower access authority.

The controller 250 controls the device interface 240 to request the device 100 for the permission information. Here, the controller 250 controls the device interface 240 to transmit the request for the permission information together with a hash of the public key of the user having the lower access authority.

After the controller 250 creates the access authority to be granted to the user having the lower access authority, the controller 250 may control the device interface 240 to request the device 100 to register the access authority.

FIG. 3 is a view illustrating a configuration of a system for creating an access authority according to another exemplary embodiment of the present invention. Referring to FIG. 3, the system includes a device 100a and a plurality of remote controllers 300 and 400.

The device 100a and the plurality of remote controllers 300 and 400 shown in FIG. 3 have similar configurations to the device 100 and the remote controller 200 shown in FIG. 1. Here, components and functions previously described will not be discussed to the extent mentioned above.

In the present exemplary embodiment, a PC 100a is taken as an example of the device 100. However, as described with reference to FIG. 1, the device 100 may be one of various types of devices including Audio/Video devices offering various kinds of contents and home games limiting access authorities for individual users.

In the present exemplary embodiment of FIG. 3, there is shown a system including a plurality of remote controllers, for creating access authority. The plurality of remote controllers include the remote controller 300, as a higher remote controller, and the remote controller 400, as a lower remote controller. The higher remote controller 300 has a higher access authority than the lower remote controller 400.

The higher remote controller 300 may be a PDA, and the lower remote controller 400 includes a PDA 400a and a cellular phone 400b, for example. However, the higher remote controller 300 and the lower remote controller 400 may not be necessarily limited to these.

The higher remote controller 300 may be a PDA or a cellular phone used by parents and guardians, and the lower remote controller 400 may be a PDA or cellular phone used by children or minors.

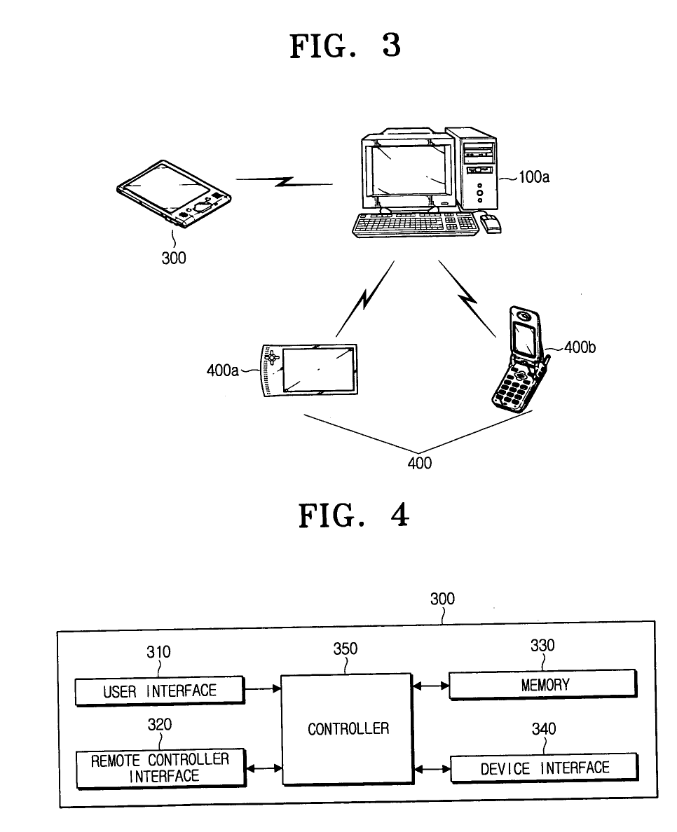

If the lower remote controller 400 requests the higher remote controller 300 to create an access authority, the higher remote controller 300 creates an access authority to be granted to the lower remote controller 400 and requests a registration of the created access authority. The higher remote controller 300 will be described in more detail later with reference to FIG. 4.

The lower remote controller 400 attaches a hash of a public key thereof to request the higher remote controller 300 to create the access authority. Here, the lower remote controller 400 requests the higher remote controller 300 to create the access authority through a location limited channel. Communications between the lower remote controller 400 and the device 100a may be performed within a range of the access authority created by the higher remote controller 300.

FIG. 4 is a block diagram of the higher remote controller 300 shown in FIG. 3. Referring to FIG. 4, the higher remote controller 300 includes a user interface 310, a remote controller interface 320, a memory 330, a device interface 340, and a controller 350.

The user interface 300 interfaces users with the higher remote controller 300 and offers the controller 350 various request signals input through manipulations of the users.

The remote controller interface 320 interfaces the higher remote controller 300 with another remote controller, i.e., the lower remote controller 400, and receives the request of the creation of the access authority from the lower remote controller 400.

The memory 330 stores a public key of the higher remote controller 300 and offers the public key to the controller 350 when the controller 350 makes a request for the public key. The memory 330 may store a public key of the lower remote controller 400 which can be input through the remote controller interface 320.

The device interface 340 interfaces the higher remote controller 300 with the device 100a and requests the device 100a to register the access authority of the lower remote controller 400 created by the controller 350.

The controller 350 controls the overall operation of the higher remote controller 300 and controls a flow of a signal among the user interface 310, the remote controller interface 320, the memory 330, and the device interface 340.

If the controller 350 receives a request for the creation of access authority through the remote controller interface 320, the controller 350 may control the device interface 340 to request permission information from the device 100a.

The controller 350 transmits the request for the permission information together with the hash of the public key of the lower remote controller 400 received through the remote controller interface 320. The controller 350 also creates the access authority to be granted to the lower remote controller 400 and controls the device interface 340 to request the device 100a to register the created access authority.

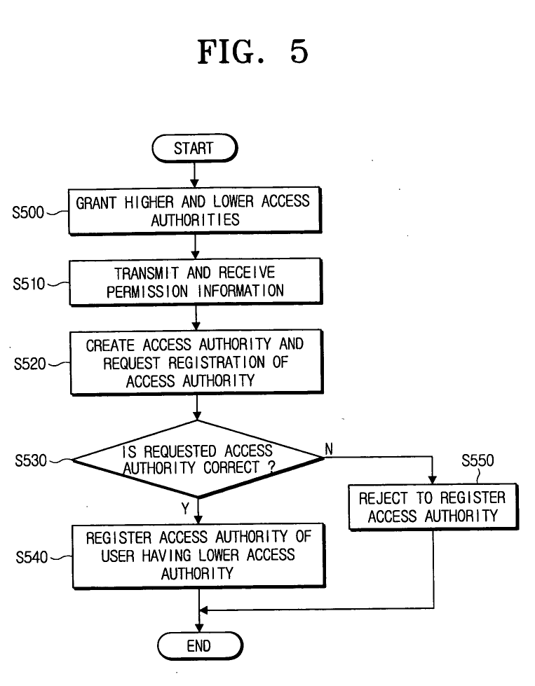

FIG. 5 is a flowchart of a method of creating an access authority according to an exemplary embodiment of the present invention. The method will now be described with reference to FIGS. 1, 2, and 5.

In operation S500, a plurality of users input a predetermined serial key through the user interface 210 to the remote controller 200 to receive corresponding access authorities from the remote controller 200. For example, guardians receive a higher access authority, and minors receive a lower access authority.

To create an access authority to the device 100 of a user having a lower access authority in the remote controller 200, the controller 250 controls the device interface 240 to request the device 100 for permission information. Here, the controller 250 attaches a hash of a public key of the user having the lower access authority to the request for the permission information. In operation S510, the device 100 offers the permission information together with a hash of a public key thereof to the remote controller 200 in response to the request of the remote controller 200, and the remote controller 200 receives the permission information through the device interface 240 from the device 100.

If a user having a higher access authority creates an access authority to be granted to the user having the lower access authority in the remote controller 200, the controller 250 controls the device interface 240 to request the device 100 to register the created access authority in operation S520.

In operation S530, the device 100 determines whether the access authority requested by the remote controller 200 is correct. In other words, the device 100 determines whether the requested access authority is lower than an access authority of the user having the higher access authority.

If the device 100 determines in operation S530 that the requested access authority is correct, the device 100 registers the requested access authority as an access authority of the user having the lower access authority in operation S540.

If the device 100 determines in operation 530 that the requested access authority is not correct, i.e., the requested access authority is higher than the access authority of the user having the higher access authority, the device 100 rejects to register the requested access authority in operation S550.

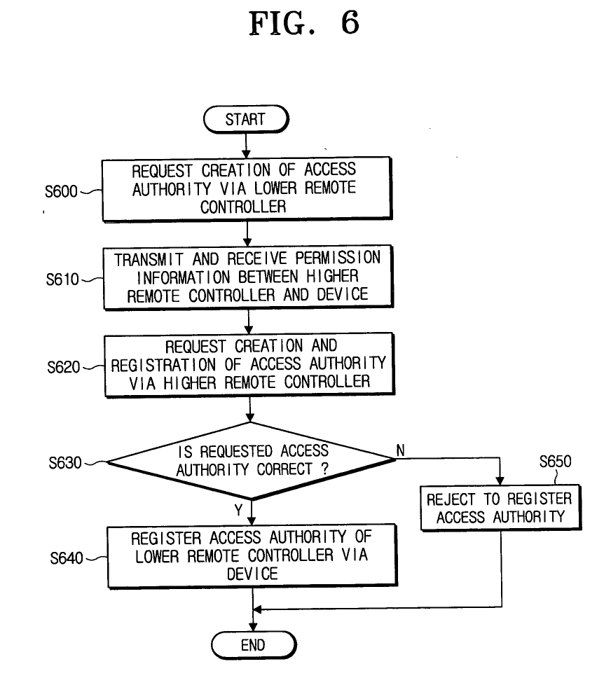

FIG. 6 is a flowchart of a method of creating an access authority according to another exemplary embodiment of the present invention. The method will now be described with reference to FIGS. 3, 4, and 6.

In operation S600, the lower remote controller 400 requests the higher remote controller 300 to create an access authority through a local limited channel. Here, the lower remote controller 400 attaches a hash of a public key thereof to the request for the creation of the access authority.

If the controller 350 of the higher remote controller 300 receives the request for the creation of the access authority through the remote controller interface 320, the controller 350 controls the device interface 340 to request the device 100 for permission information. Here, the controller 350 attaches the hash of the public key of the lower remote controller 400 received from the lower remote controller 400 to the request for the permission information. In operation S610, the device 100 offers the permission information in a webpage form.

After receiving the permission information from the device 100, the controller 350 of the higher remote controller 300 creates an access authority to be granted to the lower remote controller 400 based on the permission information. In operation S620, the controller 350 controls the device interface 340 to request the device 100 to register the created access authority.

In operation S630, the device 100 determines whether the requested access authority is correct. In other words, the device 100 determines whether the requested access authority is lower than an access authority of the higher remote controller 300.

If the device 100 determines in operation S630 that the requested access authority is lower than the access authority of the higher remote controller 300, the device 100 registers the requested access authority as an access authority of the lower remote controller 400 in operation S640.

If the device 100 determines in operation S630 that the requested access authority is higher than the access authority of the higher remote controller 300, the device 100 rejects to register the requested access authority in operation S650.

As described above, in a system and a method for creating an access authority and a remote controller using the system and the method according to the exemplary embodiments of the present invention, specific users, i.e., guardians, protectors and parents, can endow other users, i.e., their children and minors, with an access authority to a device. Thus, the children and the minors can use the device within a range of the access authority endowed by the guardians and the parents.

Also, the system and the method may be applied to devices requiring restrictions on access authority, for example, PCs, games, or the like as well as to existing image display devices. Thus, children and minors can be protected from indiscreet contents.

The foregoing embodiments are merely exemplary and are not to be construed as limiting the present invention. The present teachings can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A system for creating an access authority, the system comprising:
at least one lower remote controller which requests creation of an access authority;
a higher remote controller which receives the request for the creation of the access authority from the at least one lower remote controller, creates an access authority to be granted to the lower remote controller, and requests registration of the created access authority; and
a device which receives the request for the registration of the created access authority from the higher remote controller and registers the access authority of the lower remote controller created by the higher remote controller.

2. The system of claim 1, wherein the lower remote controller requests the higher remote controller to create the access authority through a location limited channel.

3. The system of claim 1, wherein the lower remote controller transmits the request for the creation of the access authority along with a hash of a public key of the lower remote controller.

4. The system of claim 3, wherein before creating the access authority to be granted to the lower remote controller, the higher remote controller requests the device for permission information.

5. The system of claim 4, wherein the higher remote controller transmits the request for the permission information along with the hash of the public key of the lower remote controller.

6. The system of claim 4, wherein the device offers the higher remote controller the permission information in a webpage form.

7. The system of claim 6, wherein the device offers the permission information along with a hash of a public key of the device.

8. The system of claim 1, wherein if the access authority of the lower remote controller transmitted from the higher remote controller is greater than an access authority of the higher remote controller, the device rejects to create the access authority.

9. The system of claim 1, wherein the device and the remote controller communicate with each other within a range of the access authority which is created, using a public key-based algorithm.

10. A system for creating an access authority, the system comprising:
a remote controller which grants higher and lower access authorities to a plurality of users through a user authentication, and if a user having the higher access authority creates an access authority to be granted to a user having the lower access authority, the remote controller grants a registration of the created access authority; and
a device which receives a request for the registration of the access authority which is created, from the remote controller and registers the access authority of the user having the lower access authority, the access authority being created by the user having the higher access authority.

11. The system of claim 10, wherein before creating the access authority to be granted to the user having the lower access authority, the remote controller requests the device for permission information.

12. The system of claim 11, wherein the remote controller transmits the request for the permission information along with a hash of a public key of the user having the lower access authority.

13. The system of claim 11, wherein the device offers the remote controller the permission information in a webpage form.

14. The system of claim 13, wherein the device offers the permission information along with a hash of a public key.

15. The system of claim 10, wherein if the access authority of the user having the lower access authority is higher than an access authority of the user having the higher access authority, the device does not create the access authority.

16. The system of claim 10, wherein the device and the remote controller communicate with each other within a range of the created access authority using a public key-based algorithm.

17. A method of creating an access authority in a system comprising a higher remote controller, at least one lower remote controller, and a device operated by the higher remote controller and the at least one lower remote controller, the method comprising:
requesting the higher remote controller to create an access authority via the at least one lower remote controller;
creating an access authority to be granted to the lower remote controller via the higher remote controller and requesting the device to register the created access authority; and
registering the access authority of the lower remote controller created by the higher remote controller via the device.

18. The method of claim 17, wherein the lower remote controller requests the higher remote controller to create the access authority through a location limited channel.

19. The method of claim 17, wherein the lower remote controller transmits the request for the creation of the access authority along with a hash of a public key of the lower remote controller.

20. The method of claim 19, before creating the access authority to be granted to the lower remote controller, further comprising:
requesting the device for permission information via the higher remote controller.

21. The method of claim 20, wherein the higher remote controller transmits the request for the permission information along with the hash of the public key of the lower remote controller.

22. The method of claim 20, further comprising:
offering the higher remote controller the permission information in a webpage form via the device.

23. The method of claim 22, wherein the device offers the permission information along with a hash of a public key of the device.

24. The method of claim 17, wherein if the access authority of the lower remote controller transmitted from the higher remote controller is higher than an access authority of the higher remote controller, the device does not create the access authority.

25. The method of claim 17, further comprising:
performing communications between the device and the lower remote controller within a range of the created access authority using a public key-based algorithm.

26. A method of creating an access authority in a system comprising a remote controller and a device operated by the remote controller, the method comprising:
granting, by the remote controller, higher and lower access authorities to a plurality of users through a user authentication;
creating, by the remote controller, an access authority to be granted to the user having the lower access authority via the user having the higher access authority and requesting the device to register the access authority which is created; and
registering, by the device, the access authority of the user having the lower access authority, the access authority being created by the user having the higher access authority.

27. The method of claim 26, before creating the access authority, further comprising:
requesting the device for permission information via the remote controller.

28. The method of claim 24, wherein the remote controller transmits the request for the permission information along with a hash of a public key of the user having the lower access authority.

29. The method of claim 27, further comprising:
offering the remote controller the permission information in a webpage form via the device.

30. The method of claim 29, wherein the device offers the permission information along with a hash of a public key.

31. The method of claim 26, wherein if the access authority of the user having the lower access authority is higher than the access authority of the user having the higher access authority, the device does not create the access authority.

32. The method of claim 26, further comprising:
performing communications between the device and the remote controller within a range of the access authority which is created, using a public key-based algorithm.

33. A remote controller comprising:
a user authenticator which grants higher and lower access authorities to a plurality of users via a predetermined serial key;
a controller, such that if the user having the lower access authority requests creation of an access authority, the controller creates an access authority to a device via the user having the higher access authority; and
a device interface which requests the device to register the access authority which is created.

34. A remote controller comprising:
a remote controller interface which makes a request for a creation of an access authority through a location limited channel from another remote controller;
a controller which receives the request for the creation of the access authority and creates an access authority to a device, such that the access authority is to be granted to the another remote controller; and
a device interface which requests the device to register the access authority which is created.
